(19) United States
(12) Patent Application Publication
(10) Pub. No.: US 2010/0146213 A1
(43) Pub. Date: Jun. 10, 2010

(54) Data Cache Processing Method, System And Data Cache Apparatus

(75) Inventors: Xing Yao, Shenzhen City (CN); Jian Mao, Shenzhen City (CN); Ming Xie, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/707,735

(22) Filed: Feb. 18, 2010

Related U.S. Application Data
(63) Continuation of application No. PCT/CN2008/072302, filed on Sep. 9, 2008.

(30) Foreign Application Priority Data
Sep. 11, 2007 (CN) 200710077039.3

(51) Int. Cl. G06F 12/00; G06F 12/02; G06F 12/08

(52) U.S. Cl. 711/136; 711/170; 711/E12.001; 711/E12.002; 711/E12.017; 711/118

(57) ABSTRACT

A data cache processing method, system and a data cache apparatus. The method includes: configuring a node and a memory chunk corresponding to the node in a cache, the node storing a key of data, length of the data and a pointer pointing to the memory chunk, the memory chunk storing data; and performing cache processing for the data according to the node and the memory chunk corresponding to the node.

### CROSS-REFERENCE TO RELATED APPLICATIONS

This application is a continuation of International Application No. PCT/CN2008/072302, filed Sep. 9, 2008. This application claims the benefit and priority of Chinese Application No. 200710077039.3, filed Sep. 11, 2007. The entire disclosures of each of the above applications are incorporated herein by reference.

### FIELD

The present disclosure relates to data cache technologies, and more particularly to a data cache processing method, system and a data cache apparatus.

### BACKGROUND

This section provides background information related to the present disclosure which is not necessarily prior art.

In applications of computer and Internet, in order to increase access speeds of users and decrease burdens of back-end servers, a cache technology is generally used in the front-end of a slow system or apparatus such as a database and a disk. In the cache technology, an apparatus with a rapid access speed, e.g. a memory, is used for storing data which the user often accesses. Because the access speed of the memory is much higher than that of the disk, the burden of the back-end apparatus can be decreased and user requests can be responded in time.

The cache may store various types of data, e.g. attribute data and picture data of a user, various types of files which the user needs to store, etc. FIG. 1 is a schematic diagram illustrating a structure of a conventional cache. A cache 11 includes a head structure, a Hash bucket and multiple nodes. In the head structure, the location of the Hash bucket, the depth of the Hash bucket, i.e. the number of Hash values, the number of nodes, and the number of used nodes and so on are stored. In the Hash bucket, a head pointer of a node chain corresponding to each Hash value is stored, and the head pointer points to one node. Because a pointer in each node points to a next node until to the last node, a whole node chain can be obtained according to the head pointer.

Each node stores a key, data and a pointer pointing to a next node, and is a main operating cell for caching. When the length of a node chain corresponding to a certain Hash value is not enough, an additional node chain composed of multiple nodes is set for backup, and a head pointer of the additional node chain is stored in an additional head. The additional node chain is organized as the node chain.

When one record is inserted, data to be written into a cache and a key corresponding to the data are obtained, a Hash value is determined according to the key by using a Hash algorithm, a node chain corresponding to the Hash value is traversed sequentially to search for a record corresponding to the key; if a record corresponding to the key exists, the record is updated; if a record corresponding to the key does not exist, the data is inserted into the last node of the node chain. If nodes in the node chain have been used up, the key and the data are stored in an additional node chain to which a head pointer of the additional node chain points.

When one record is read, a Hash value corresponding to the record is determined according to a key of the record by using the Hash algorithm, a node chain corresponding to the Hash value is traversed sequentially to search for a record corresponding to the key; if a record corresponding to the key does not exist, an additional node chain is searched; if a record corresponding to the key exists, data corresponding to the record are returned.

When one record is deleted, a Hash value corresponding to the record is determined according to a key of the record by using the Hash algorithm, a node chain corresponding to the Hash value is traversed sequentially to search for a record corresponding to the key; if a record corresponding to the key does not exist, an additional node chain is searched, and the key and data corresponding to the record are deleted after the record corresponding to the key is searched out.

In the conventional cache technology, since one block of data must be stored in one node, a data space in the node must be larger than the length of data to be stored. In this way, it is needed to learn the size of data to be cached before using a cache, so as to avoid that larger data can not be cached. In addition, since sizes of data in practical applications generally have large differences and each block of data needs to occupy one node, the memory space is often wasted; and the smaller the data is, the larger the wasted memory space is. Further, record searching efficiency is low; if a record is not searched out after a single node chain is searched, the additional node chain needs to be searched, and thus the consumed time is much more if the additional node chain is long.

### SUMMARY

This section provides a general summary of the disclosure, and is not a comprehensive disclosure of its full scope or all of its features.

Embodiments of the present invention provide a data cache processing method to solve a problem that memory space is wasted and record searching efficiency is low when data is cached by using a conventional cache structure.

The embodiments of the present invention are implemented as follows: a data cache processing method includes:
configuring, in a cache, a node and a memory chunk corresponding to the node, the node storing a key of data, length of the data and a pointer pointing to the memory chunk, the memory chunk storing the data; and
performing cache processing for the data according to the node and the memory chunk corresponding to the node.

Embodiments of the present invention also provide a data cache processing system, including:
a cache configuring module, adapted to configure a node and a memory chunk corresponding to the node in a cache, the node storing a key of data, length of the data and a pointer pointing to the memory chunk, the memory chunk storing data; and
a cache processing operating module, adapted to perform cache processing according to the node and the memory chunk.

Embodiments of the present invention further provide a data cache apparatus, including:
a head structure, adapted to store a location of a Hash bucket, depth of the Hash bucket, the total number of nodes in the node region, the number of used nodes, the number of used Hash buckets and an idle node chain head pointer;
a Hash bucket, adapted to store a node chain head pointer corresponding to each Hash value; and
at least one node, adapted to store a key of data, length of the data, a memory chunk chain head pointer corresponding to the node, a node chain former pointer and a node chain later pointer;
the memory chunk region comprises:
a head structure, adapted to store the total number of memory chunks in the memory chunk region, size of a memory chunk, the total number of idle memory chunks and an idle memory chunk chain head pointer; and
at least one memory chunk, adapted to store data to be written into the data cache apparatus, and a next memory chunk pointer.

In the embodiments of the present invention, nodes of a cache, memory chunks corresponding to the nodes, a key of data stored in the node, the length of data in the node and a pointer pointing to a corresponding memory chunk are configured, data are stored in the memory chunks, and various data cache processing operations are performed according to the node and the memory chunks corresponding to the node. The embodiments of the present invention have little requirements for the size of data and good universality, do not need to learn the size and distribution of stored single data, which increases the universality of cache, decreases the waste of memory space, and increases the usability of memory.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating a structure of a conventional cache.

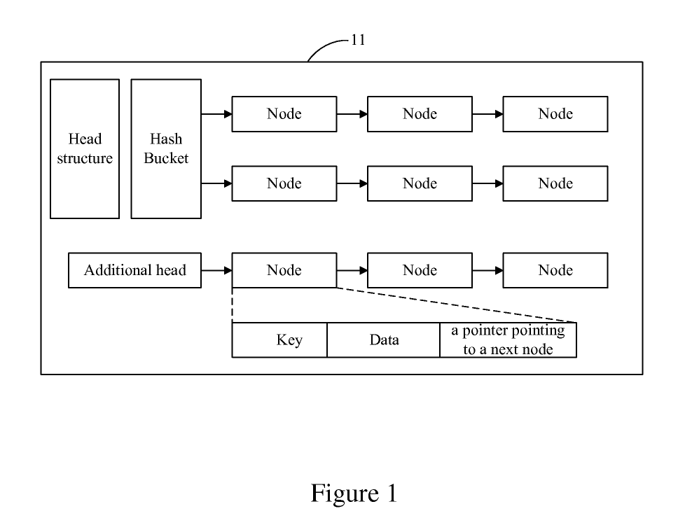

FIG. 2 is a schematic diagram illustrating a structure of a cache according to an embodiment of the present invention.

FIG. 3 is a flowchart of inserting a record into a cache according to an embodiment of the present invention.

FIG. 4 is a flowchart of reading a record from a cache according to an embodiment of the present invention.

FIG. 5 is a flowchart of deleting a record from a cache according to an embodiment of the present invention.

FIG. 6 is a schematic diagram illustrating a structure of a data cache processing system according to an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to make the object, technical schemes and merits of the present invention clearer, the present invention is described hereinafter in detail with reference to accompanying drawings and embodiments. It should be understand that the embodiments described herein are only used to explain the present invention, and are not used to limit the present invention.

In the embodiments of the present invention, nodes, memory chunks corresponding to the nodes are configured in a cache. The node stores a key of data, length of the data and a pointer pointing to the memory chunk. In the node, the length of the data is used to represent the size of data practically stored through the node. Data is stored in the memory chunks, and various data cache processing operations, e.g. inserting a record, reading a record or deleting a record, are performed according to the nodes and the memory chunks corresponding to the nodes.

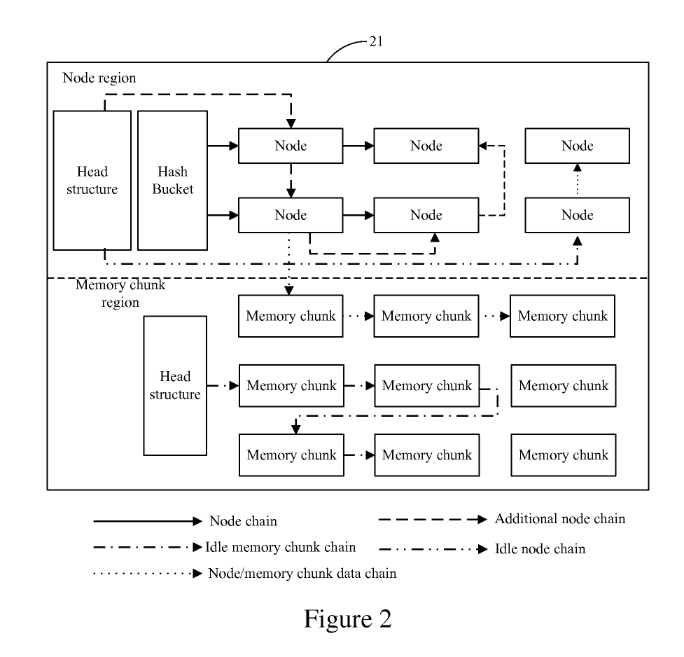

FIG. 2 is a schematic diagram illustrating a structure of a cache according to an embodiment of the present invention. A cache 21 includes a node region and a memory chunk region. The memory chunk region is a shared memory region allocated in a memory. The shared memory region is divided into at least one memory chunk for storing data. Data corresponding to one node may be stored in multiple memory chunks, and the number of needed memory chunks is determined according to the size of the data. In the node, a key, the length of data and a pointer pointing to a memory chunk corresponding to the node are stored.

The node region includes a head structure, a Hash bucket and at least one node. The head structure mainly stores the following information:
1. the location of the Hash bucket, pointing to a start location of the Hash bucket;
2. the depth of the Hash bucket, representing the number of Hash values in the Hash bucket;
3. the total number of nodes, representing the number of records which the cache can store at most;
4. the number of the used nodes;
5. the number of the used Hash buckets, representing the number of current node chains in the Hash bucket;
6. a Least Recently Used (LRU) operation additional chain head pointer, pointing to the head of a LRU operation additional chain;
7. a LRU operation additional chain tail pointer, pointing to the tail of the LRU operation additional chain;
8. an idle node chain head pointer, pointing to the head of an idle node chain; when needing to allocate a node every time, a node is taken out from the idle node chain, and the idle node chain head pointer points to the next node.

The Hash bucket mainly stores a node chain head pointer corresponding to each Hash value. According to a key corresponding to data, a Hash value corresponding to key is determined by using a Hash algorithm, the location of the Hash value at the Hash bucket is obtained, a node chain head pointer corresponding to the Hash value is searched for, so as to search out a whole node chain corresponding to the Hash value.

The node stores the following information:
1. a key, adapted to determine a record exclusively; keys of different records are different;
2. a length of data, representing the length of data practically stored through the node, according to which the number of needed memory chunks can be determined;
3. a memory chunk chain head pointer, pointing to one memory chunk in the memory chunk chain for storing data of the node, by which a whole memory chunk chain corresponding to the node is obtained;
4. a node chain former pointer, pointing to a previous node in the current node chain;
5. a node chain later pointer, pointing to a next node in the current node chain;
6. a node using state chain former pointer, pointing to a previous node in the node using state chain;
7. a node using state chain later pointer, pointing to a next node in the node using state chain;
8. a last visiting time, recording the time of the last visit to the record;
9. visiting times, recording the times of visits to the record in the cache.

In the embodiments of the present invention, node configurations, e.g. node inserting or deleting can be performed flexibly for a node chain according to the node chain former pointer and the node chain later pointer. For example, when a node is deleted, a node chain later pointer of a previous node of this node and a node chain former pointer of a next node of this node are adjusted according to the node chain former pointer and the node chain later pointer of this node, so as to make the node chain from which the node is deleted continuous.

In addition, in the embodiments of the present invention, operations of the cache, e.g. the LRU operation can be implemented by using the node using state chain head pointer, the node using state chain tail pointer, the node using state chain former pointer, the node using state chain later pointer, and the last visiting time and visiting times of the node; the LRU data in the node are removed from the memory, and memory chunks and node corresponding to the LRU data are reclaimed, so as to save the memory space.

In the embodiments of the present invention, the using state of the node is recorded, and the LRU operation is performed according to the last visiting time and visiting times of the node, so as to replace the node. When a node is visited, a node using state chain later pointer of a previous node of this node points to a next node of this node, a node using state chain former pointer of a next node of this node points to a previous node of this node, so as to make the previous node of this node connect with the next node of this node; and then the node using state chain later pointer of this node points to a node to which the node using state chain head pointer points, and the node using state chain head pointer points to this node, so that this node is inserted in the head of the node using state chain. When another node is visited, similar processing is performed, and the node using state chain tail pointer points to a LUR node. When the LRU operation is performed, data in the memory chunk corresponding to the node to which the node using state chain tail pointer points are deleted, and the memory chunk corresponding to the node is reclaimed.

The memory chunk region mainly stores a chain structure of memory chunks and data of records, and includes a head structure and at least one memory chunk.

The head structure mainly stores the following information:
1. the total number of memory chunks, representing the total number of the memory chunks in the memory chunk region;
2. the size of a memory chunk, representing the length of data which one memory chunk can store;
3. the total number of idle memory chunks, representing the most length of data which the cache can further store;
4. an idle memory chunk chain head pointer, pointing to the head of an idle memory chunk chain; when needing to allocate a memory chunk every time, an idle memory chunk is taken out from the idle memory chunk chain.

The memory chunk includes a data region and a memory chunk later pointer, respectively adapted to practically store the data of the records and a next memory chunk pointer. If one memory chunk is not enough to store the data of one record, multiple memory chunks can be connected, and the data are stored in a data region corresponding to each memory chunk.

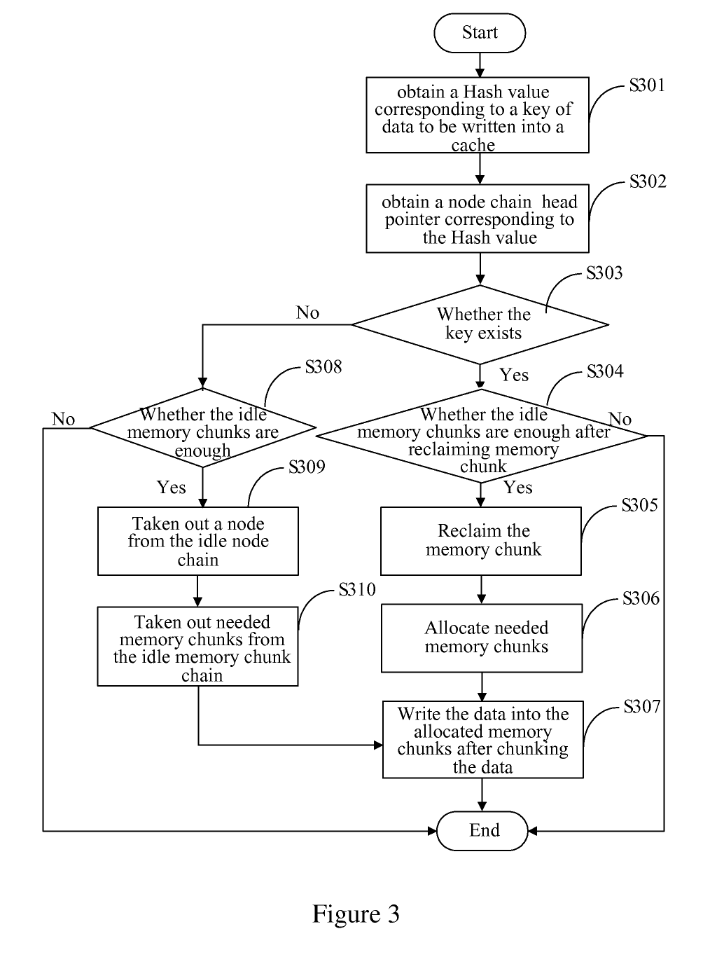

FIG. 3 is a flowchart of inserting a record in a cache according to an embodiment of the present invention, and the flowchart is described as follows.

In Step S301, data to be written in a cache and a key corresponding to the data are obtained, and a Hash value is obtained according to the key by using a Hash algorithm.

In Step S302, a node chain head pointer corresponding to the Hash value is obtained according to the location of the Hash value at the Hash bucket.

In Step S303, a node chain in the Hash bucket is traversed according to the node chain head pointer, and it is determined whether the key is searched out; if the key is searched out, Step S304 is performed; otherwise, Step S308 is performed.

In Step 304, it is determined whether idle memory chunks can accommodate the data to be written into the cache after reclaiming memory chunks which store a record corresponding to the key; if the idle memory chunks can accommodate the data to be written in the cache, Step S305 is performed; otherwise, the procedure terminates.

In Step S305, data of the record corresponding to the key are deleted, and the memory chunks from which the data are deleted are reclaimed.

In Step S306, needed memory chunks are reallocated according to the length of data in the node.

In Step S307, the data are written in the allocated memory chunks in turn after the data are chunked, to form a memory chunk chain for storing the data, and a memory chunk chain head pointer of the node points to the head of the memory chunk chain.

In Step S308, it is determined whether idle memory chunks can accommodate the data to be written in the cache; if the idle memory chunks can accommodate the data to be written in the cache, Step S309 is performed; otherwise, the procedure terminates.

In Step S309, a node is taken out from an idle node chain.

In Step S310, memory chunks are allocated according to the length of the data to be stored and the size of a memory chunk, the allocated memory chunks are taken out from an idle memory chunk chain, and Step S307 is performed, i.e. the data are written in the allocated memory chunks in turn after the data are chunked, to form the memory chunk chain for storing the data, and the memory chunk chain head pointer of the node points to the head of the memory chunk chain.

In the embodiments of the present invention, when a record is inserted, if the quantity of data exceeds the quantity of data which one memory chunk can store, the data need to be chunked and stored in multiple memory chunks. Suppose that N memory chunks are needed, each of the former n−1 data chunks stores data the quantity of which equals to the capacity of the memory chunk, and the last memory chunk stores the remained data, the remained data may be smaller than the capacity of the memory chunk. The procedure of reading one record is opposite, the data in the memory chunks are read in turn, and a whole data block is recovered.

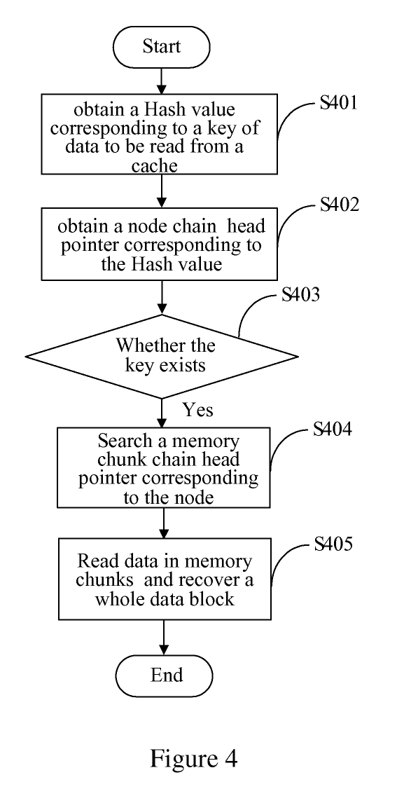

FIG. 4 is a flowchart of reading a record from a cache according to an embodiment of the present invention, and the flowchart is described as follows.

In Step S401, a key corresponding to data to be read is obtained, and a Hash value corresponding to the key is obtained according to the key by using a Hash algorithm.

In Step S402, a node chain head pointer corresponding to the Hash value is searched for according to the location of the Hash value at the Hash bucket.

In Step S403, a node chain in the Hash bucket is traversed according to the node chain head pointer, and it is determined whether the key is searched out; if the key is searched out, Step S404 is performed; otherwise, the procedure terminates.

In Step S404, a memory chunk chain head pointer corresponding to the node is searched for.

In Step S405, data in memory chunks are read in turn from the memory chunk chain to which the memory chunk chain head pointer points, a whole data block is recovered and the data are returned to the user.

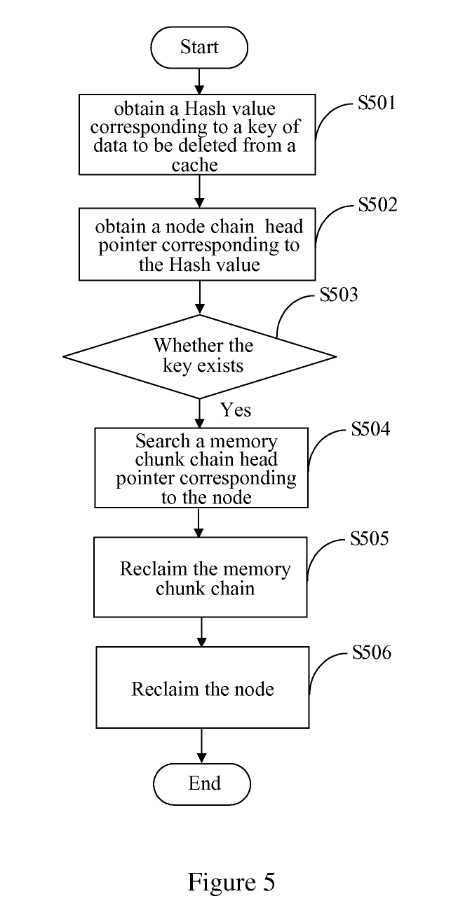

FIG. 5 is a flowchart of deleting a record from a cache according to an embodiment of the present invention, and the flowchart is described as follows.

In Step S501, a key corresponding to data to be deleted from a cache is obtained, and a Hash value corresponding to the key is obtained according to the key by using a Hash algorithm.

In Step S502, a node chain head pointer corresponding to the Hash value is searched for according to the location of the Hash value at the Hash bucket.

In Step S503, a node chain in the Hash bucket is traversed according to the node chain head pointer, and it is determined whether the key is searched out; if the key is searched out, Step S504 is performed; otherwise, the procedure terminates.

In Step S504, a memory chunk chain head pointer corresponding to the node is searched.

In Step S505, data stored in a memory chunk chain corresponding to the memory chunk chain head pointer are deleted, and the memory chunks are reclaimed to the idle memory chunk chain.

In Step S506, the memory chunk chain head pointer of the node points to the idle node chain, so as to reclaim the node to the idle node chain.

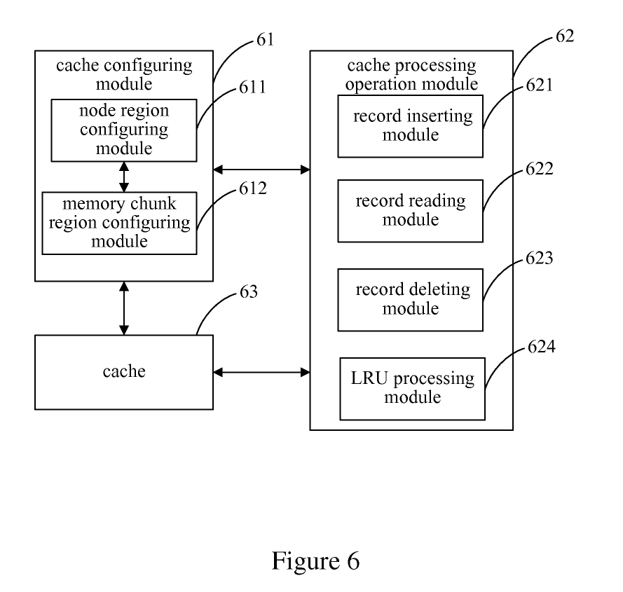

FIG. 6 is a schematic diagram illustrating a structure of a data cache processing system according to an embodiment of the present invention. The structure is described as follows.

A cache configuring module 61 is adapted to configure a node and a memory chunk corresponding to the node in a cache 63. The node stores a key of data, the length of the data and a pointer pointing to the memory chunk. The memory chunk corresponding to the node stores data written in the cache 63. As mentioned in the foregoing, the node includes the key of the data, the length of the data, a memory chunk chain head pointer corresponding to the node, a node chain former pointer, a node chain later pointer and so on.

When the cache 63 is configured, a node region configuring module 611 is adapted to configure information stored in a node region, and the node region includes a head structure, a Hash bucket and at least one node. The head structure of the node region, the Hash bucket and the information stored in the node are as mentioned in the foregoing, and will not be described. A memory chunk region configuring module 612 is adapted to configure information stored in the memory chunk region. The memory chunk region includes a head structure and at least one memory chunk. The head structure of the memory chunk region and the information stored in the memory chunk are as mentioned in the foregoing, and will not be described.

A cache processing operation module 62 is adapted to perform cache processing for data according to the configured node and memory chunk corresponding to the node.

When a record is inserted, a record inserting module 621 is adapted to search a node chain according to a key corresponding to data to be written into the cache 63; when the key exists in the node chain, delete data in a memory chunk corresponding to the key, reclaim the memory chunk from which the data are deleted, allocate a memory chunk according to the size of data of the record, and write the data of the record into the allocated memory chunk in turn after chunking the data; when the key does not exist in the node chain, allocate one idle node and a memory chunk corresponding to the length of the data, and write the data into the allocated memory chunks in turn.

When a record is read, a record reading module 622 is adapted to search a node chain according to a key corresponding to the data to be read from the cache 63; when the key exists in the node chain, read data in a memory chunk corresponding to the key in turn, and recover a whole data block.

When a record is deleted, a record deleting module 623 is adapted to search a node chain according to a key corresponding to the data to be deleted from the cache 63; when the key exists in the node chain, delete data in a memory chunk corresponding to the key, and reclaim the memory chunk from which the data are deleted and the node corresponding to the key.

As an embodiment of the present invention, a LRU processing module 624 is adapted to perform a LRU operation for data in the cache 63 according to a last visiting time and visiting times of a record, remove LRU data from the memory, and reclaim memory chunks and node, to save the memory space.

The embodiments of the present invention have little requirements for the size of the data and have good generality, and do not need to learn the size and distribution of stored single data, which increases universality of the cache, effectively decreases waste of the memory space, and increases usability of memory. Simultaneously, data searching efficiency is high and the LRU operation is supported.

The foregoing descriptions are only preferred embodiments of the present invention and are not for use in limiting the protection scope thereof. Any modification, equivalent replacement and improvement made under the spirit and principle of the present invention should be included in the protection scope thereof.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A data cache processing method, comprising:
configuring, in a cache, a node and a memory chunk corresponding to the node, the node storing a key of data, length of the data and a pointer pointing to the memory chunk, the memory chunk storing the data; and
performing cache processing for the data according to the node and the memory chunk corresponding to the node.

2. The method of claim 1, wherein when a record is inserted, performing cache processing for the data according to the node and the memory chunk corresponding to the node comprises:
determining whether a key corresponding to data of the record exists in a node chain, the node chain comprising the node configured;
when the key exists in the node chain and if total capacity of idle memory chunks can accommodate the data after a memory chunk corresponding to the key is reclaimed, reclaiming the memory chunk corresponding to the key, allocating a memory chunk according to the length of the data, and writing the data into the memory chunk allocated in turn after chunking the data; and
when the key does not exist in the node chain and if total capacity of idle memory chunks can accommodate the data, allocating an idle node and a memory chunk according to the length of the data, and writing the data into the memory chunk allocated after chunking the data.

3. The method of claim 1, wherein when a record is read, performing cache processing for the data according to the node and the memory chunk corresponding to the node comprises:
determining whether a key corresponding to data of the record exists in a node chain, the node chain comprising the node configured; if the key exists in the node chain, reading data in a memory chunk corresponding to the key in turn according to a pointer pointing to the memory chunk and the length of data, and recovering a whole data block; otherwise, terminating the procedure.

4. The method of claim 1, wherein when a record is deleted, performing cache processing for the data according to the node and the memory chunk corresponding to the node comprises:
determining whether a key corresponding to data of the record exists in a node chain, the node chain comprising the node configured; if the key exists in the node chain, deleting data in a memory chunk corresponding to the key in turn according to a pointer pointing to the memory chunk and the length of data, and reclaiming the memory chunk and the node; otherwise, terminating the procedure.

5. The method of claim 1, wherein the configured node stores a last visiting time and visiting times of a record, and performing cache processing for the data according to the node and the memory chunk corresponding to the node comprises:
performing a Least Recently Used (LRU) operation for the data in the cache according to the last visiting time and visiting times of the record.

6. A data cache processing system, comprising:
a cache configuring module, adapted to configure a node and a memory chunk corresponding to the node in a cache, the node storing a key of data, length of the data and a pointer pointing to the memory chunk, the memory chunk storing data; and
a cache processing operating module, adapted to perform cache processing according to the node and the memory chunk.

7. The system of claim 6, wherein the cache configuring module comprises:
a node region configuring module, adapted to configure information stored in a node region, and the node region comprises a head structure, a Hash bucket and at least one node; and
a memory chunk region configuring module, adapted to configure information stored in a memory chunk region, and the memory chunk region comprises a head structure and at least one memory chunk.

8. The system of claim 6, wherein the cache processing operating module comprises:
a record inserting module, adapted to search a node chain according to a key corresponding to data to be written into the cache; when the key exists in the node chain, delete data in a memory chunk corresponding to the key, reclaim the memory chunk, allocate a memory chunk according to the length of the data, and write the data into the memory chunk allocated in turn after chunking the data; when the key does not exists in the node chain, allocate an idle node and a memory chunk according to the length of the data, and write the data into the memory chunk allocated in turn after chunking the data.

9. The system of claim 6, wherein the cache processing operating module comprises:
a record reading module, adapted to search a node chain according to a key corresponding to data to be read from the cache; when the key exists in the node chain, read data from a memory chunk corresponding to the key in turn according to a pointer pointing to the memory chunk and the length of the data, recovery a whole data block.

10. The system of claim 6, wherein the cache processing operating module comprises:
a record deleting module, adapted to search a node chain according to a key corresponding to data to be deleted from the cache; when the key exists in the node chain, delete data from a memory chunk corresponding to the key according to a pointer pointing to the memory chunk and the length of the data, reclaim the memory chunk and the node.

11. The system of claim 6, wherein the cache processing operation module comprises:
a Least Recently Used (LRU) processing module, adapted to perform a LRU operation for the data in the cache according to a last visiting time and visiting times of a record.

12. A data cache apparatus, comprising a node region and a memory chunk region; wherein the node region comprises:
a head structure, adapted to store a location of a Hash bucket, depth of the Hash bucket, the total number of nodes in the node region, the number of used nodes, the number of used Hash buckets and an idle node chain head pointer;
a Hash bucket, adapted to store a node chain head pointer corresponding to each Hash value; and
at least one node, adapted to store a key of data, length of the data, a memory chunk chain head pointer corresponding to the node, a node chain former pointer and a node chain later pointer;
the memory chunk region comprises:
a head structure, adapted to store the total number of memory chunks in the memory chunk region, size of a memory chunk, the total number of idle memory chunks and an idle memory chunk chain head pointer; and
at least one memory chunk, adapted to store data to be written into the data cache apparatus, and a next memory chunk pointer.

13. The apparatus of claim 12, wherein the head structure in the node region is further adapted to store a Least Recently Used (LRU) operation additional chain head pointer and a LRU operation additional chain tail pointer; and
the node is further adapted to store a node using state chain former pointer, a node using state chain later pointer, a last visiting time and visiting times of the node.
